(19) United States
(12) Patent Application Publication
(10) Pub. No.: US 2022/0333011 A1
(43) Pub. Date: Oct. 20, 2022

(54) PROCESS FOR PREPARING MULTICOLOR, FLUORESCENT CARBON QUANTUM DOT NANOPARTICLES FROM COAL UNDER MILD OXIDATION CONDITIONS

(71) Applicants: West Virginia University Board of Governors on Behalf of West Virginia University, Morgantown, WV (US); Georgia Tech Research Corporation, Atlanta, GA (US)

(72) Inventors: Hanjing TIAN, Morgantown, WV (US); Sheng DAI, Marietta (CN); Jianli HU, Morgantown, WV (US)

(21) Appl. No.: 17/753,278

(22) PCT Filed: Aug. 28, 2020
(86) PCT No.: PCT/US2020/048527

§ 371 Date: Feb. 25, 2022

Related U.S. Application Data
(60) Provisional application No. 62/893,385, filed on Aug. 29, 2019.
(60) Provisional application No. 62/893,385, filed on Aug. 29, 2019.

(51) Int. Cl. C09K 11/65; C01B 32/15

(52) U.S. Cl. CPC C09K 11/65; C01B 32/15; C01P 2004/64; B82Y 30/00

(57) ABSTRACT

In one aspect, the disclosure relates to multicolored carbon quantum dot nanoparticles (Cdots), “one-pot” methods of making same starting from coal and using mild reaction conditions, and applications of the same. The disclosed methods are safe and environmentally benign as well as inexpensive. Additionally, the disclosed carbon quantum dot nanoparticles are stable and have tunable properties based on reaction conditions used for their synthesis.

### CROSS REFERENCE TO RELATED APPLICATIONS

This application claims the benefit of U.S. Provisional Application No. 62/893,385, filed on Aug. 29, 2019, which is incorporated herein by reference in its entirety.

### STATEMENT REGARDING FEDERALLY SPONSORED RESEARCH OR DEVELOPMENT

This invention was made with U.S. Government support under grant number 1511818 awarded by the National Science Foundation. The U.S. government has certain rights in the invention.

### BACKGROUND

Commercially, carbon quantum dot nanoparticles (C-dots) are made from organic chemicals via a “bottom-up” approach. Individual carbon-containing molecules (C1-C10), such as carbohydrates and citrate, can be agglomerated into nanoparticles (<10 nm) via chemical methods, such as electrochemical synthesis, thermal combustion, supported synthesis, microwave-ultrasonic methods; or physical methods such as arc charge, laser ablation, or plasma treatment. C-dots prepared via the “bottom-up” approach are indicated by a single color or single excitation within the visible or ultra-violet (UV) range.

Improvement of the commercial production of carbon quantum dot nanoparticles (C-dots) has long been a goal for researchers, as C-dots are expensive and labor intensive to produce while also being strongly fluorescent and thus useful for applications in bioimaging, drug delivery, optoelectronics, heavy metal detection (e.g. Hg, Pb, Se, Cu), and sensing applications, among others.

Commercial-level C-dots are not prepared using the reverse approach, referred to as the “top-down” method. This method breaks large carbon clusters, such as graphene, graphite, carbon nanotubes, nanodiamonds, and bio-char into C-dots. Moreover, very few reports produce C-dot materials directly from coal or coal derivatives as the raw material. Electrochemical methods and/or acidic exfoliation are generally used for the top-down approach. However, although breaking C—C bonds in coal using strong acids (i.e., a mixture of nitric acid and sulfuric acid as in published reports) at a laboratory scale, such highly-concentrated, corrosive exfoliation is essentially impossible for process development and industrial applications. Coal-derived carbon dots have also been prepared using a 4-step H₂O₂ extraction method with strong ball milling. However, the fluorescence of these C-dots was ultimately attributed to a surface 2-hydroxyterephthalic acid complex, which essentially decayed in 2-5 min. In general, known “top-down” approaches are complex, multi-step methods with relatively long reaction periods, sometimes exceeding 15 hours, that do not result in C-dot products with impressive shelf stability for most applications. Known C-dot production methods are also challenging to employ at industrial scales.

Innovation in C-dot synthesis technology is required to mitigate synthesis conditions while using an inexpensive and abundant raw material, such as coal, to improve energy efficiency and reduce capital and operating costs. A “one-pot” synthesis approach with mild oxidation conditions, for the preparation of C-dots from coal with stable and strong fluorescence would be highly desirable as well as fundamentally different from previous approaches. Ideally, such a method could produce C-dot materials with multi-color or multiple UV-visible excitations, offering additional advantages for imaging and heavy metal detection over currently-available single-color C-dot products. These needs and other needs are satisfied by the present disclosure.

### SUMMARY

In accordance with the purpose(s) of the present disclosure, as embodied and broadly described herein, the disclosure, in one aspect, relates to multicolored carbon quantum dot nanoparticles (C-dots), “one-pot” methods of making same starting from coal and using mild reaction conditions, and applications of the same. The disclosed methods are safe and environmentally benign as well as inexpensive. Additionally, the disclosed carbon quantum dot nanoparticles are stable and have tunable properties based on reaction conditions used for their synthesis.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows two exemplary reaction pathways for synthesizing carbon quantum nano-dots (C-dots) as described herein. Polycyclic starting materials from coal can be treated with FeCl₃ alone or in combination with DMF and/or H₂O₂ to generate fluorescent products.

FIG. 2 shows exemplary C-dots synthesized using the methods disclosed herein.

FIGS. 3A-3B show aspects of an exemplary process for synthesizing C-dots as disclosed herein. In FIG. 3A, coal and Fe³⁺ alone or in combination with H₂O₂ or DMF are added to a reactor and optionally mechanically stirred. FIG. 3B shows that following the synthesis reaction, with or without mixing, the quantum dots can optionally be contacted with additives prior to product collection.

FIG. 4 shows fluorescence excitation spectra of multiple colors of C-dots prepared according to the disclosed process. Emission wavelength was set at 460 nm and excitation spectra showed one C-dot having an intense peak at 150 nm (light gray line), a second C-dot having a less intense peak at 150 nm (medium gray line), and a third C-dot having a peak at 100 nm and a peak at 200 nm (black line). Inset: electrophoresis images of the C-dots in the visible and UV ranges.

FIG. 5 shows electrophoresis images of C-dots. The addition of Fe³⁺ to H₂O₂ during the synthesis reaction resulted in significantly higher fluorescence intensity (lane 11) than H₂O₂ without Fe³⁺.

FIG. 6A shows fluorescence excitation and emission spectra for C-dots synthesized from coal and Fe³⁺. FIG. 6B shows fluorescence excitation and emission spectra for commercial fluorescent polystyrene latex microspheres (FLUORESBRITE® carboxylate microspheres from Polysciences, Warrington, Pa.) for comparative purposes.

FIG. 7 shows fluorescence excitation and emission spectra for C-dots synthesized from coal, DMF, and Fe³⁺.

FIG. 8 shows fluorescence excitation and emission spectra for C-dots synthesized from coal, H₂O₂ and Fe³⁺.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a surfactant,” “an additive,” or “an oxidant,” includes, but is not limited to, mixtures or combinations of two or more such surfactants, additives, or oxidants, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, “nanoparticle” refers to a particle on the nanometer scale, usually having a diameter of between about 1 nm and 100 nm. In some aspects, a nanoparticle can have a diameter as large as 500 nm. In one aspects, the C-dots disclosed herein are nanoparticles having an average diameter of about 10 nm, or less than about 10 nm. In another aspect, the sizes of the disclosed C-dots can be measured by transmission electron microscopy (TEM).

“Quantum dots” as used herein refers to semiconductor nanoparticles. In one aspect, when quantum dots are illuminated by UV and/or visible light, one or more electrons can be excited from the valence band to the conductance band; when the electron drops back to the valence band, light can be emitted. In a further aspect, wavelength of emitted light can be tuned based on particle size and composition, coatings, and other factors.

As used herein, “multicolored” refers to quantum dots having a plurality of peaks in the absorbance spectrum and/or the fluorescence emission and excitation spectra thereof.

A “stable” quantum dot or quantum dot composition refers to a quantum dot or quantum dot composition that retains at least 90% of its optical properties (e.g., intensity and peak locations in absorbance or fluorescence spectra) after a period of storage. In one aspect, the period of storage is at least two months, at least three months, at least four months, at least five months, or at least six months. In another aspect, the temperature of storage can be up to about 100° C.

In one aspect, the C-dots disclosed herein are “biocompatible.” A “biocompatible” material as used herein is a material that can be placed in contact with a living system (for example, an organ, cell, or tissue to be imaged) without causing harm to or producing any adverse effects in the living system.

“Anthracite” coal is a hard, brittle, glossy black coal. Anthracite coal typically contains a high percentage of fixed carbon and relatively little volatile matter including low moisture content.

“Bituminous coal” is a black or dark brown coal that often appears banded or layered. “High-volatile” bituminous coal can be classified on the basis of its energy value on a moist, ash-free basis. “Medium volatile” bituminous coal and “low volatile” bituminous coal are classified on the percentage of fixed carbon on a dry, ash-free basis (69-78% and 78-86%, respectively).

“Sub-bituminous coal” is a rank of coal having properties between those of lignite and bituminous coal and typically has a lower sulfur content than lignite coal.

“Lignite coal” is a soft, brown coal with the lowest concentration of carbon of any coal type.

As used herein, “mild reaction conditions” refer to temperatures generally below 150° C., pressures generally below 3 atm, pH near neutral (e.g., from about 5 to about 9), and lacking the presence of strong acids. In some aspects, mild reaction conditions can include reaction times under about 10 h, or from about 2 to about 5 h.

As used herein, a “one pot reaction” refers to a chemical synthesis where a single reactant is subjected to one or more reactions in a single reactor. In some aspects, in a one pot reaction, no purification or workup is performed between reaction steps, although such may be performed following the final reaction step. In another aspect, the synthesis of C-dots as disclosed herein can be carried out as a one-pot reaction.

A “surfactant” as used herein is a compound that lowers interfacial tension between two substances such as, for example, between a liquid (e.g., aqueous) medium and a solid (e.g., coal particles). In one aspect, a surfactant such as, for example, dimethylformamide, can be used when synthesizing C-dots by the processes disclosed herein.

Unless otherwise specified, temperatures referred to herein are based on atmospheric pressure (i.e. one atmosphere).

### Method for Making Carbon Quantum Dot Nanoparticles

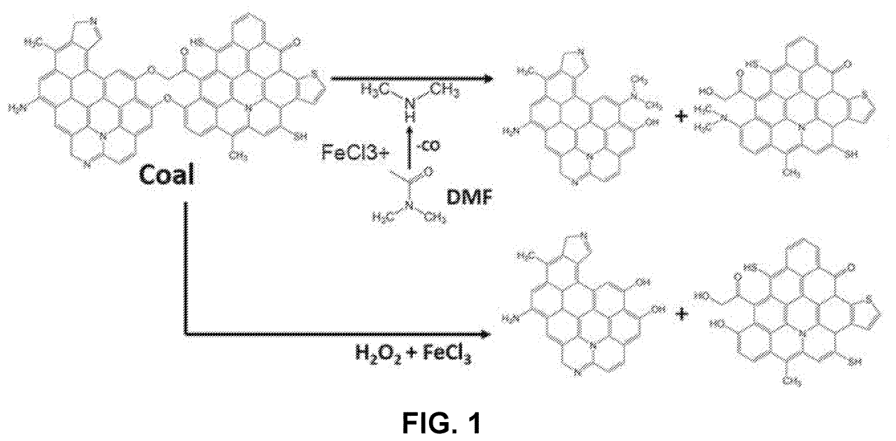

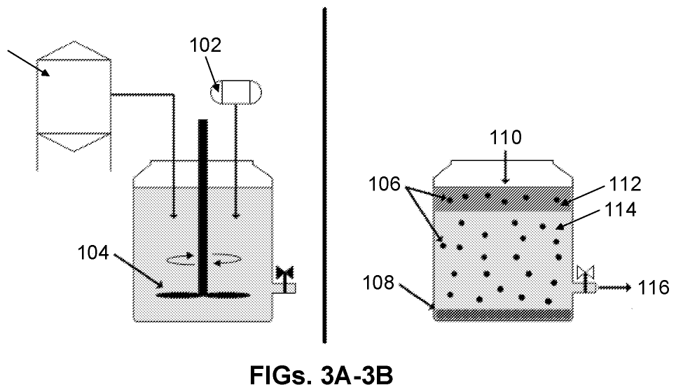

In one aspect, disclosed herein is a method for making carbon quantum dot nanoparticles (C-dots), the method including at least the steps of contacting coal with an oxidant to form a first mixture and heating the first mixture. An exemplary synthetic scheme for the reaction is shown in FIG. 1, while FIGS. 3A-3B show a synthetic process useful herein. In FIG. 3A, pulverized coal 100 is added to a reactor along with oxidant and/or surfactant 102 and optionally mixed with mixing device 104. Following mixing, optional additives 106 are added to C-dots 108, while undissolved oxides 110 sink to the bottom of the reactor, leaving oil phase 112 on the top of the reactor and water phase 114 filling the bulk of the reactor; product collection occurs through valve or outlet 116 (FIG. 3B). In a further aspect, the reactor can be an autoclave reactor. In one aspect, undissolved oxides 110 make up less than about 1% by weight of the total carbon in the final product, while the oil phase contains about 5% by weight of the C-dots and the water phase contains about 95% weight percent of the C-dots. In one aspect, oil phase 112 can be a side product of coal decomposition. In another aspect, water in water phase 114 can be a solvent in which one or more oxidants is provided (e.g., a 30% v/v solution of H₂O₂ in water).

In one aspect, the method does not require or rely on the use of strong reaction conditions such as, for example, acids (e.g., H₂SO₄, HNO₃), thus increasing the safety and industrial scalability of the method as well as reducing costs. In a further aspect, C-dots formed by the disclosed method are stable at temperatures below 100° C. for a period of up to several months. In another aspect, without wishing to be bound by theory, Fe³⁺ can also act as a catalyst to decompose H₂O₂ and/or DMF when used in combination with Fe³⁺, which can result in higher C-dot yields.

In one aspect, the structure of coal when mined is complex but, following processing including, but not limited to, pulverization and/or another method to reduce the particle size, can be simplified as angstrom or nanometer-scale structures having macromolecular defects mainly consisting of sp² carbon and an adjacent layer linked by aliphatic bridging carbon. In a further aspect, these structural defects can be readily broken apart under mild conditions such as those used in the disclosed processes. Without wishing to be bound by theory, the mechanism of the disclosed process (see FIG. 1) differs from the acidic exfoliation mechanism of synthesizing C-dots, such that the products produced are also distinct in structure and properties.

In some aspects, the disclosed method is a “one-pot” reaction. In another aspect, the reaction can be conducted in pH conditions ranging from about 5 to about 9, or at about 5, 5.5, 6. 6.5, 7, 7.5, 8, 8.5, or about 9, or a combination of any of the foregoing values, or a range encompassing any of the foregoing values. In some aspects, the method can be performed in a continuous reactor.

### Coal Type

In some aspects, the pulverized coal can be a bituminous coal, a sub-bituminous coal, an anthracite coal, a lignite coal, or any combination thereof. In one aspect, when the coal is or includes a sub-bituminous coal, the sub-bituminous coal can be a Wyodak coal. In another aspect, when the coal is a bituminous coal, the coal can be a high volatile bituminous coal, a medium volatile bituminous coal, or a low volatile bituminous coal. In one aspect, when the coal is a high volatile bituminous coal, it can be an IL #6 coal.

In any of these aspects, the coal is pulverized and has an average particle diameter of from about 50 to about 200 μm, or from about 53 to about 177 μm, or about 50, 75, 100, 125, 150, 175, or about 200 μm, or a combination of any of the foregoing values, or a range encompassing any of the foregoing values. In one aspect, the average particle diameter is about 100 μm. In an alternative aspect, the average particle diameter can be represented as “mesh,” relating to the pore or opening size of a sieve, filter, or strainer used to separate coal particles of different sizes. In another aspect, the coal particles can be from about 50 to about 300 mesh, or from about 80 to about 270 mesh, or about 50, 100, 150, 200, 250, or about 300 mesh, or a combination of any of the foregoing values, or a range encompassing any of the foregoing values.

In one aspect, coal fines can be used as feedstock regardless of moisture content. In a further aspect, coal can be ground for use in the disclosed methods, or coal fines can be recovered from coal wastes and/or slurry and used in the disclosed methods.

### Oxidant

In one aspect, the oxidant can be an Fe³⁺ salt. In a further aspect, the Fe³⁺ salt can be FeCl₃ or another salt. In some aspects, the Fe³⁺ salt and the coal can be present in a ratio of about 0.2 g Fe³⁺ salt to about 1 g of pulverized coal.

In another aspect, the oxidant can be H₂O₂. In a further aspect, the H₂O₂ and coal can be present in a ratio of about 20 mL of H₂O₂ to about 1 g of pulverized coal.

### Surfactant

In some aspects, the first mixture further comprises a surfactant. In one aspect, the surfactant can be dimethylformamide (DMF). In another aspect, the surfactant and the coal can be present in a ratio of about 1 mL of surfactant to about 1 g of pulverized coal.

### Reaction Conditions

In one aspect, the mixture can be heated to a temperature of from about 70 to about 150° C., or to about 70, 75, 80, 85, 90, 95, 100, 105, 110, 115, 120, 125, 130, 135, 140, 145, or about 150, or a combination of any of the foregoing values, or a range encompassing any of the foregoing values. In another aspect, the reaction can be conducted at a pressure of from about 1 atm to about 3 atm, or of about 1, 1.25, 1.5, 1.75, 2, 2.25, 2.5, 2.75, or about 3 atm, or a combination of any of the foregoing values, or a range encompassing any of the foregoing values. In one aspect, the first mixture can be heated to a temperature of about 150° C. or less. In another aspect, the reaction can be conducted at a pressure of about 3 atm or less (about 304 kPa or less). In still another aspect, the reaction can be conducted for from about 2 h to about 5 h, or for about 2, 2.5, 3, 3.5, 4, 4.5, or about 5 h, or a combination of any of the foregoing values, or a range encompassing any of the foregoing values.

In one aspect, the first mixture can be mechanically stirred. In some aspects, the first mixture further includes a solvent. In some aspects, the solvent can be water. In still other aspects, the first mixture further includes at least one additive.

### Exemplary Reactions

In one aspect, the coal can be a Wyodak coal and the oxidant can be an Fe³⁺ salt. In another aspect, the coal can be an IL #6 coal and the oxidant can be an Fe³⁺ salt. In still another aspect, the coal can be a Wyodak coal, the oxidant can be an Fe³⁺ salt, and the surfactant can be DMF. In one aspect, the coal can be a Wyodak coal and the oxidant can be an Fe³⁺ salt and H₂O₂.

In any of these aspects, the method can yield from about 50% to about 85% of carbon quantum dot nanoparticles relative to the amount of pulverized coal, or about 50, 55, 60, 65, 70, 75, 80, or about 85% of C-dots relative to the starting amount of pulverized coal, or a combination of any of the foregoing values, or a range encompassing any of the foregoing values.

### Characteristics of Carbon Quantum Dot Nanoparticles

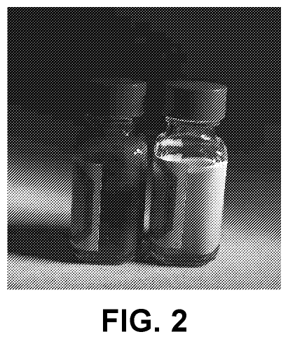

In one aspect, disclosed herein are C-dots made by the disclosed methods. In another aspect, the C-dots can have an average particle size of less than about 10 nm. In one aspect, the C-dots are multicolored. In an alternative aspect, the C-dots can have a single color. In still another aspect, the color of the C-dots is tunable based on reaction conditions including, but not limited to, starting coal type, presence and speed of stirring, oxidant used, surfactant used, additive used, starting coal particle size, and the like. Exemplary C-dots prepared by the methods disclosed herein are shown in FIG. 2.

In some aspects, the C-dot surfaces can be functionalized. In one aspect, functionalized C-dot surfaces can present oxygen-containing functional groups which can enhance water solubility.

### Fluorescence Excitation and Emission Wavelengths

In one aspect, the carbon quantum dot nanoparticles disclosed herein can have a maximum fluorescence excitation wavelength of from about 360 nm to about 500 nm, or of about 360, 370, 380, 390, 400, 410, 420, 430, 440, 450, 460, 470, 480, 490, or about 500 nm, or a combination of any of the foregoing values, or a range encompassing any of the foregoing values. In another aspect, the C-dots disclosed herein can have a maximum fluorescence emission wavelength of from about 300 nm to about 400 nm, or of about 300, 310, 320, 330, 340, 350, 360, 370, 380, 390, or about 400 nm, or a combination of any of the foregoing values, or a range encompassing any of the foregoing values.

In one aspect, the C-dots have a maximum fluorescence excitation wavelength of about 449 nm and a maximum fluorescence emission wavelength of about 358 nm. In one aspect, the C-dots have a maximum fluorescence excitation wavelength of about 488 nm and a maximum fluorescence emission wavelength of about 388 nm. In one aspect, the C-dots have a maximum fluorescence excitation wavelength of about 365 nm and a maximum fluorescence emission wavelength of about 350 nm.

Without wishing to be bound by theory, in one aspect, the C-dots prepared by the disclosed process are multicolored due to the heterogeneous structure of the starting coal materials.

### Advantages of the Disclosed Methods

In one aspect, the method disclosed herein is environmentally benign. Further in this aspect, the method does not use harsh solvents or strong acids and requires a lower energy input than other methods for producing C-dots, since lower temperatures and pressures can be used, as well as a shorter reaction time. In another aspect, the method does not produce toxic emissions. In still another aspect, the method does not require intricate or costly purification steps.

In one aspect, the method allows for the direct utilization of coal as a raw material, avoiding the need to process intermediates such as tar, active carbon, carbon fibers, graphene oxide, or the like. In another aspect, the method can be operated continuously or in a batch or semi-batch mode and can be scaled for industrial production. In still another aspect, the method reduces capital expenditures and operating expenses compared to other methods for producing C-dots.

### Applications of Carbon Quantum Dot Nanoparticles

### Bioimaging

In one aspect, the disclosed C-dots can be used in bioimaging applications. In a further aspect, compared to fluorescent organic dyes and genetically engineered fluorescent proteins, the C-dots have a higher photoluminescence quantum yield, are photostable, and are resistant to metabolic degradation, making them particularly suitable for biological applications in general.

In one aspect, aqueous phase C-dots disclosed herein can be used directly in bioimaging. In a further aspect, water solubility has been a barrier to effective use of prior quantum dots in bioimaging applications; thus, the presently disclosed C-dots are advantageous in imaging applications over previously known quantum dots.

In some aspects, the C-dots can be conjugated to ligands for biomarkers of interest (e.g., pathogen biomarkers, tumor biomarkers, or the like) such as, for example, antibodies, peptides, or small molecule drugs. Further in these aspects, the C-dots localize around the desired biomarkers through ligand binding to the biomarkers; the fluorescence properties of the C-dots then allow imaging of, for example, the tumor expressing the biomarkers.

In another aspect, the C-dots can be used in dynamic cellular imaging such as, for example, by conjugating the quantum dots to neurotransmitters, hormones, or other signaling molecules, and using imaging techniques (e.g., fluorescence microscopy) to visualize the same. In one aspect, the C-dots are photostable even in the intracellular environment.

In another aspect, the C-dots disclosed herein are biocompatible and can be cleared from the body, both of which are desirable for in vivo applications and both of which stand in contrast to some heavy metal-based quantum dots, which may present toxicity concerns.

### Drug Delivery

In one aspect, the C-dots disclosed herein can be useful for drug delivery applications. In some aspects, C-dots functionalized with biomarker targets as well as drugs can slowly release the drugs overtime in a desired location in the body of a subject, eliminating the need for multiple doses of the drug while also minimizing systemic toxicity and/or side effects. In other aspects, the C-dots can be simultaneously used to image the drug target (e.g., a tumor) as well as release the drug, thus allowing for monitoring of treatment progress (e.g., tumor size shrinking).

### Microfluidic Devices

In still another aspect, the C-dots disclosed herein are useful in microfluidic devices. Without wishing to be bound by theory, the high surface area-to-volume ratio of C-dots results in surface tension and viscosity being dominant over inertial effects, thus making fluids easier to manipulate. In some aspects, using the C-dots in microfluidic devices allows for detection of low concentrations of analytes in solution such as, for example, virus particles, genetic mutations in DNA (e.g. by conjugating the C-dots to a complementary DNA strand), and the like.

### Ionic Detection

In still another aspect, the C-dots disclosed herein are useful for ionic detection. In one aspect, the fluorescence intensity of the C-dots is influenced by the surrounding environment. In a further aspect, the interaction between the C-dots and chemicals can result in the quenching or enhancement of C-dot emission. Thus, in one aspect, the C-dots are useful as fluorescent probes to detect the concentration of ions in the surrounding solution. In a further aspect, the C-dots can be particularly useful for sensing heavy metals such as, for example, mercury, copper, lead, selenium, and the like. In some aspects, the C-dots can be used for sensing metals in cell interiors. In one aspect, the C-dots can be conjugated to small molecules for Hg²⁺ detection (e.g., mercaptoacetic acid, L-cysteine, N-acetyl-L-cysteine) or Pb²⁺ detection (e.g., thioglycolic acid, glutathione, dithizone). In another aspect, the C-dots can be conjugated to supramolecular structures for Hg²⁺ detection (e.g., sulfur calix[4]arene, calix[6]arene) or Cd²⁺ detection (e.g., 1,10-diaza-18-crown-6). In still another aspect, the C-dots can be conjugated to DNA sequences having specific interactions with heavy metals (e.g. T-Hg²⁺-T base pairs, Pb²⁺ stabilized G-quadruplexes), proteins, or other known heavy metal ligands.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

The present disclosure can be described in accordance with the following numbered Aspects, which should not be confused with the claims.

Aspect 1. A method for making carbon quantum dot nanoparticles, the method comprising contacting coal with an oxidant to form a first mixture and heating the first mixture, wherein the oxidant comprises an Fe3+ salt.
Aspect 2. The method of aspect 1, wherein the coal comprises a bituminous coal, a sub-bituminous coal, an anthracite coal, a lignite coal, or any combination thereof.
Aspect 3. The method of aspect 2, wherein the sub-bituminous coal comprises a Wyodak coal.
Aspect 4. The method of aspect 2, wherein the bituminous coal comprises a high volatile bituminous coal, a medium volatile bituminous coal, or a low volatile bituminous coal.
Aspect 5. The method of aspect 4, where the high volatile bituminous coal comprises an IL #6 coal.
Aspect 6. The method of any of aspects 1-5, further comprising passing the coal through a sieve prior to performing the method.
Aspect 7. The method of aspect 6, wherein the sieve is from about 80 to about 270 mesh.
Aspect 8. The method of any of aspects 1-7, wherein the coal comprises pulverized coal having an average particle diameter of from about 50 to about 200 μm.
Aspect 9. The method of any of aspects 1-7, wherein the coal comprises pulverized coal having an average particle diameter of about 100 μm.
Aspect 10. The method of any of aspects 1-9, wherein the Fe3+ salt comprises FeCl3.
Aspect 11. The method of any of aspects 1-10, wherein the Fe3+ salt and the coal are present in a ratio of about 0.2 g:1 g.
Aspect 12. The method of any of aspects 1-11, wherein the oxidant further comprises H2O2.
Aspect 13. The method of aspect 12, wherein the H₂O₂ comprises a 30% solution in water.
Aspect 14. The method of aspect 12 or 13, wherein the H₂O₂ and the coal are present in a ratio of about 20 mL:1 g.
Aspect 15. The method of any of aspects 1-14, wherein the first mixture further comprises a surfactant.
Aspect 16. The method of aspect 15, wherein the surfactant comprises dimethylformamide (DMF).
Aspect 17. The method of aspect 15 or 16, wherein the surfactant and coal are present in a ratio of about 1 mL:1 g.
Aspect 18. The method of any of aspects 1-17, wherein the first mixture is heated to a temperature of from about 70° C. to about 150° C.
Aspect 19. The method of any of aspects 1-18, wherein the method is conducted at a pressure of from about 1 to about 3 atmospheres.
Aspect 20. The method of any of aspects 1-19, wherein the method is conducted for from about 2 hours to about 5 hours.
Aspect 21. The method of any of aspects 1-20, further comprising mechanically stirring the first mixture.
Aspect 22. The method of any of aspects 1-21, wherein the first mixture further comprises a solvent.
Aspect 23. The method of aspect 22, wherein the solvent comprises water.
Aspect 24. The method of any of aspects 1-23, wherein the first mixture further comprises an additive.
Aspect 25. The method of any of aspects 1-24, wherein the method is performed at a pH of from about 5 to about 9.
Aspect 26. The method of any of aspects 1-25, wherein the coal comprises a Wyodak coal and the surfactant comprises dimethylformamide.
Aspect 27. The method of any of aspects 1-25, wherein the coal comprises a Wyodak coal and the oxidant comprises an Fe3+ salt and H2O2.
Aspect 28. The method of any of aspects 1-27, wherein the method yields carbon quantum dot nanoparticles having an average particle size of less than about 10 nm.
Aspect 29. The method of any of aspects 1-28, wherein the method yields from about 50% to about 85% of carbon quantum dot nanoparticles relative to the amount of coal.
Aspect 30. Carbon quantum dot nanoparticles produced by the method of any of aspects 1-29.
Aspect 31. The carbon quantum dot nanoparticles of aspect 30, wherein the carbon quantum dot nanoparticles are multicolored.
Aspect 32. The carbon quantum dot nanoparticles of aspect 30 or 31, wherein the carbon quantum dot nanoparticles have a maximum fluorescence excitation wavelength of from about 360 nm to about 500 nm and a maximum fluorescence emission wavelength of from about 300 nm to about 400 nm.
Aspect 33. The carbon quantum dot nanoparticles of any of aspects 30-32, wherein the carbon quantum dot nanoparticles have a maximum fluorescence excitation wavelength of about 449 nm and a maximum fluorescence emission wavelength at about 358 nm.
Aspect 34. The carbon quantum dot nanoparticles of any of aspects 30-32, wherein the carbon quantum dot nanoparticles have a maximum fluorescence excitation wavelength of about 488 nm and a maximum fluorescence emission wavelength at about 388 nm.
Aspect 35. The carbon quantum dot nanoparticles of any of aspects 30-32, wherein the carbon quantum dot nanoparticles have a maximum fluorescence excitation wavelength of about 365 nm and a maximum fluorescence emission wavelength at about 350 nm.
Aspect 36. The carbon quantum dot nanoparticles of any of aspects 30-35, wherein the carbon quantum dot nanoparticles are stable at temperatures below 100° C. for a period of at least two months.
Aspect 37. A method for making carbon quantum dot nanoparticles, the method comprising contacting coal with an oxidant to form a first mixture and heating the first mixture, wherein the oxidant comprises H2O¬2.
Aspect 38. The method of aspect 37, wherein the H₂O₂ comprises a 30% solution in water.
Aspect 39. The method of aspect 37 or 38, wherein the coal comprises a bituminous coal, a sub-bituminous coal, an anthracite coal, a lignite coal, or any combination thereof.
Aspect 40. The method of aspect 39, wherein the sub-bituminous coal comprises a Wyodak coal.
Aspect 41. The method of aspect 39, wherein the bituminous coal comprises a high volatile bituminous coal, a medium volatile bituminous coal, or a low volatile bituminous coal.
Aspect 42. The method of aspect 41, where the high volatile bituminous coal comprises an IL #6 coal.
Aspect 43. The method of any of aspects 37-42, further comprising passing the coal through a sieve prior to performing the method.
Aspect 44. The method of aspect 43, wherein the sieve is from about 80 to about 270 mesh.
Aspect 45. The method of any of aspects 37-44, wherein the coal comprises pulverized coal having an average particle diameter of from about 50 to about 200 μm.
Aspect 46. The method of any of aspects 37-44, wherein the coal comprises pulverized coal having an average particle diameter of about 100 μm.
Aspect 47. The method of any of aspects 37-46, wherein the H₂O₂ and the coal are present in a ratio of about 20 mL:1 g.
Aspect 48. The method of any of aspects 37-47, wherein the first mixture further comprises a surfactant.
Aspect 49. The method of aspect 48, wherein the surfactant comprises dimethylformamide (DMF).
Aspect 50. The method of aspect 48 or 49, wherein the surfactant and coal are present in a ratio of about 1 mL:1 g.
Aspect 51. The method of any of aspects 37-50, wherein the first mixture is heated to a temperature of from about 70° C. to about 150° C.
Aspect 52. The method of any of aspects 37-51, wherein the method is conducted at a pressure of from about 1 to about 3 atmospheres.
Aspect 53. The method of any of aspects 37-52, wherein the method is conducted for from about 2 hours to about 5 hours.
Aspect 54. The method of any of aspects 37-53, further comprising mechanically stirring the first mixture.
Aspect 55. The method of any of aspects 37-54, wherein the first mixture further comprises a solvent.
Aspect 56. The method of aspect 55, wherein the solvent comprises water.
Aspect 57. The method of any of aspects 37-56, wherein the first mixture further comprises an additive.
Aspect 58. The method of any of aspects 37-57, wherein the method is performed at a pH of from about 5 to about 9.
Aspect 59. The method of any of aspects 37-58, wherein the coal comprises a Wyodak coal and the surfactant comprises dimethylformamide.
Aspect 60. The method of any of aspects 37-59, wherein the method yields carbon quantum dot nanoparticles having an average particle size of less than about 10 nm.
Aspect 61. The method of any of aspects 37-60, wherein the method yields from about 50% to about 85% of carbon quantum dot nanoparticles relative to the amount of coal.
Aspect 62. Carbon quantum dot nanoparticles produced by the method of any of aspects 37-61.
Aspect 63. The carbon quantum dot nanoparticles of aspect 62, wherein the carbon quantum dot nanoparticles are multicolored.
Aspect 64. The carbon quantum dot nanoparticles of aspect 62 or 63, wherein the carbon quantum dot nanoparticles have a maximum fluorescence excitation wavelength of from about 360 nm to about 500 nm and a maximum fluorescence emission wavelength of from about 300 nm to about 400 nm.
Aspect 65. The carbon quantum dot nanoparticles of any of aspects 62-64, wherein the carbon quantum dot nanoparticles have a maximum fluorescence excitation wavelength of about 449 nm and a maximum fluorescence emission wavelength at about 358 nm.
Aspect 66. The carbon quantum dot nanoparticles of any of aspects 62-64, wherein the carbon quantum dot nanoparticles have a maximum fluorescence excitation wavelength of about 488 nm and a maximum fluorescence emission wavelength at about 388 nm.
Aspect 67. The carbon quantum dot nanoparticles of any of aspects 62-64, wherein the carbon quantum dot nanoparticles have a maximum fluorescence excitation wavelength of about 365 nm and a maximum fluorescence emission wavelength at about 350 nm.
Aspect 68. The carbon quantum dot nanoparticles of any of aspects 62-64, wherein the carbon quantum dot nanoparticles are stable at temperatures below 100° C. for a period of at least two months.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

Wyodak (sub bituminous) or IL #6 (high volatile bituminous) coal was obtained from the Penn State University coal bank.

In a typical reaction, a 100 mL laboratory-scale batch reactor was used. For 1 g of coal, 20 mL H₂O₂ (30% v/v in water) and 0.2 g FeCl₃ were used. In the experiments that follow, about 1 mL of surfactant (dimethylformamide, or DMF) was added to promote C-dot formation. In some experiments, H₂O₂, FeCl₃, and/or DMF were used in combination or alone. Reaction time was less than 10 h. In some experiments, coal decomposition resulted in the formation of an oil phase.

FIGS. 3A-3B illustrate the “one-pot” process via a mild oxidation solution. Coal is pulverized into about 100 μm-sized particles and introduced into the pot followed by Fe³⁺ and optionally H₂O₂ and/or DMF. The reactor is a conventional autoclave able to operate at pressure conditions up to 3 atm and is kept at a temperature of about 150° C.

If necessary, for better liquid-solid contact, the mixture is mechanically stirred at a rate no greater than 500 rpm. After a 2-5 h destruction period, the formed C-dots have a particle size less than 10 nm. Additives such as surfactants are optionally added after the destruction period to obtain certain final C-dot product characteristics. The fluorescence characteristics of C-dots produced using this method are not sensitive to coal type.

The final hydrothermal solution is in three semi-stratified phases (FIG. 3B): (1) undissolved solid oxides (<1 vol %), which can be easily separated, and the (2) oil (˜5 vol %) and (3) water (>95 vol %) phases, which can be readily settled in about 10 min and directly used for bioimaging applications.

The disclosed reactions produce an excellent yield in the range of 50-85%, where C-dot yield is defined as the ratio between the C-dot powder and the initial amount of coal excluding solid impurities.

A Bio-Rad 1D/2D Protean i12IEF Electrophoresis System for SDS-PAGE, 2D, 1D, and Western blot was used in electrophoresis experiments. A Horiba Jobin Yvon Fluorolog-3 Spectrofluorometer was used for fluorescence experiments. A JEOL JEM-2100 Transmission Electron Microscope was used for imaging.

### Example 2: Synthesis of Multicolored C-Dots

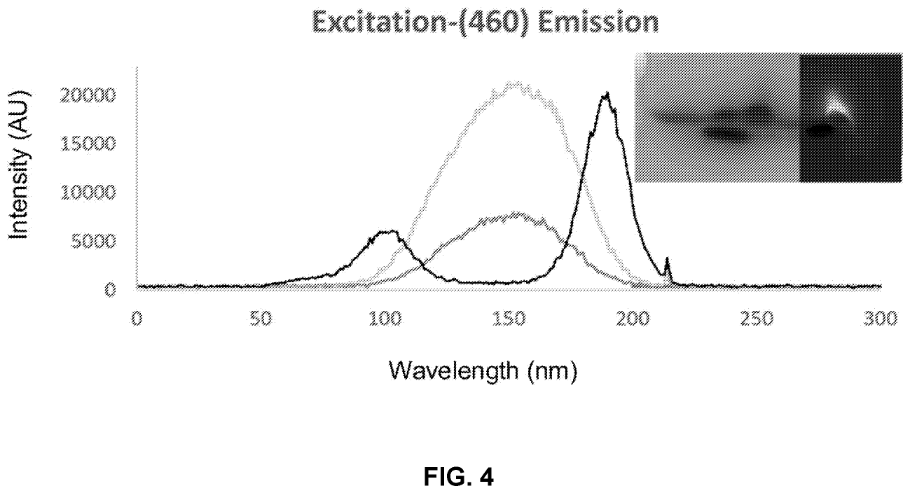

Coal-derived, multi-colored C-dots were prepared via a one-pot approach in a FeCl₃ solution. A laboratory scale batch reactor (100 mL) with 0.2 g FeCl₃ per 1 g of coal created about a 65% C-dot yield (FIG. 4). Reaction time was about 5 h.

The C-dot sample was prepared in multiple colors due to the heterogeneous nature of coal structure. Fluorescence excitation spectra were collected using a Fluorolog-3 Spectrofluorometer with a 460 nm emission wavelength. Different C-dot colors are shown having maxima at 150 nm (light gray), 100 and 200 nm (black) and 150 nm (medium gray). Electrophoresis images in the visible and UV range are shown in the photographs to the right in FIG. 4.

### Example 3: Effect of Fe³⁺

C-dots synthesized according to the disclosed procedure using H₂O₂ and using Fe³⁺ and H₂O₂ were subjected to electrophoresis and fluorescence imaging with an excitation wavelength of 470 nm and an emission filter of 695 nm.

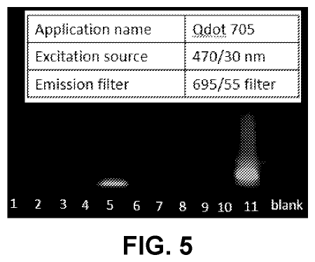

The addition of Fe³⁺ (FIG. 5, lane 11) to C-dot syntheses using H₂O₂ exhibited significantly more fluorescence intensity than C-dots synthesized without using Fe³⁺ (FIG. 5, lane 5).

### Example 4: Unique Fluorescence Characteristics of the Synthesized C-Dots

### Reactions Using Fe³⁺ Alone

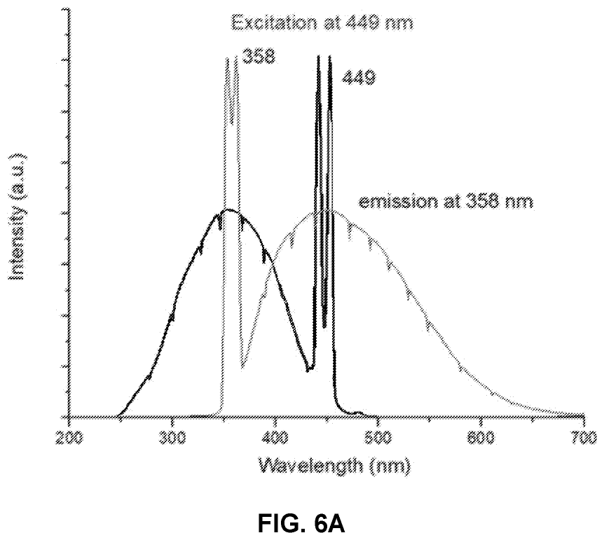

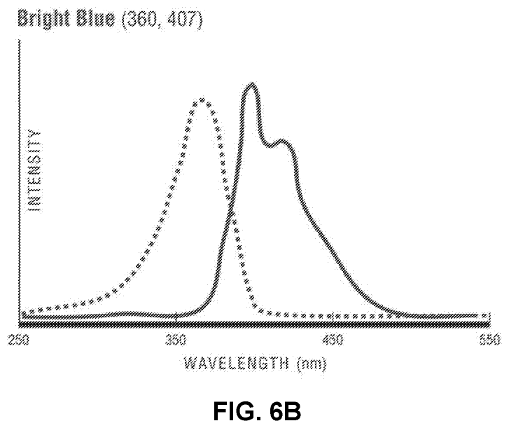

Fluorescence excitation and emission spectra of a C-dot sample prepared using Wyodak coal and Fe³⁺ alone (without H₂O₂ or DMF) in a 5 h reaction are shown in FIG. 6A. The C-dot yield was 55% for the Wyodak coal, with two types of C-dots being produced. The C-dots had an emission maximum at 358 nm, while the excitation maximum was at 449 nm, which differs significantly from FLUORESBRITE® Carboxylate Microspheres, which have excitation and emission maxima at 360 and 407 nm, respectively (FIG. 6B). A comparative experiment performed with IL #6 coal demonstrated identical fluorescence characteristics but a slightly higher C-dot yield (62%, data not shown).

### Reactions Using Fe³⁺ and DMF

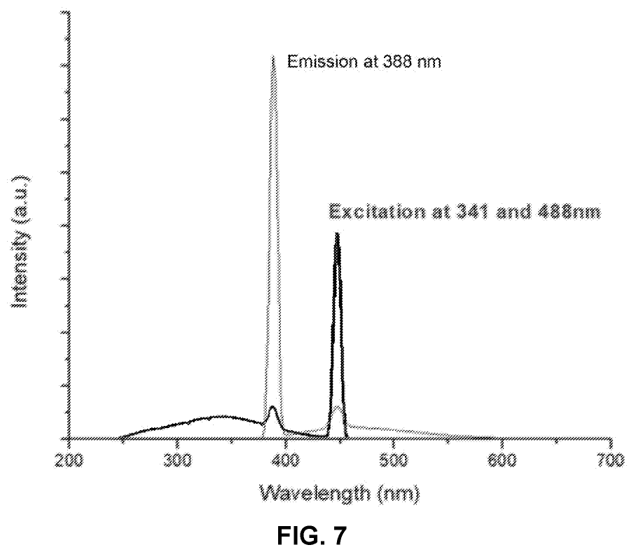

Fluorescence excitation and emission spectra of a C-dot sample prepared using Wyodak coal and Fe³⁺ with DMF in a 5 h reaction are shown in FIG. 7. Two types of C-dots were produced. The C-dots had an emission maximum at 388 nm and an excitation maximum at 488 nm with a wide shoulder at 300 to 420 nm, which differs significantly from FLUORESBRITE® Carboxylate Microspheres, which have excitation and emission maxima at 360 and 407 nm, respectively (FIG. 6B).

Reactions Using Fe³⁺ and H₂O₂

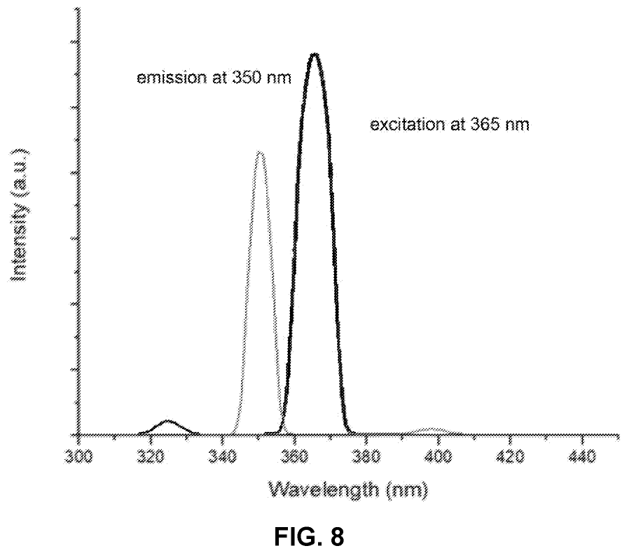

Fluorescence excitation and emission spectra of a C-dot sample prepared using Wyodak coal and Fe³⁺ with H₂O₂ in a 5 h reaction period are shown in FIG. 8. Two types of C-dots were produced. The C-dots had an emission maximum at 350 nm and an excitation maximum at 365 nm. Each spectrum showed an additional small peak which indicated another minor species was present. These spectra differ significantly from FLUORESBRITE® Carboxylate Microspheres, which have excitation and emission maxima at 360 and 407 nm, respectively (FIG. 6B).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method for making carbon quantum dot nanoparticles, the method comprising contacting coal with an oxidant to form a first mixture and heating the first mixture, wherein the oxidant comprises an Fe³⁺ salt.

2. The method of claim 1, wherein the coal comprises a bituminous coal, a sub-bituminous coal, an anthracite coal, a lignite coal, or any combination thereof.

3. The method of claim 1, wherein the coal is pulverized and comprises an average particle diameter of from about 50 to about 200 μm.

4. The method of claim 1, wherein the oxidant comprises FeCl₃.

5. The method of claim 1, wherein the oxidant further comprises H₂O₂.

6. The method of claim 1, wherein the first mixture further comprises a surfactant.

7. The method of claim 6, wherein the surfactant comprises dimethylformamide (DMF).

8. The method of claim 1, further comprising mechanically stirring the first mixture.

9. The method of claim 1, wherein the method yields carbon quantum dot nanoparticles having an average particle size of less than about 10 nm.

10. Carbon quantum dot nanoparticles produced by the method of claim 1.

11. The carbon quantum dot nanoparticles of claim 10, wherein the carbon quantum dot nanoparticles have a maximum fluorescence excitation wavelength of from about 360 nm to about 500 nm and a maximum fluorescence emission wavelength of from about 300 nm to about 400 nm.

12. A method for making carbon quantum dot nanoparticles, the method comprising contacting coal with an oxidant to form a first mixture and heating the first mixture, wherein the oxidant comprises H₂O₂.

13. The method of claim 12, wherein the coal comprises a bituminous coal, a sub-bituminous coal, an anthracite coal, a lignite coal, or any combination thereof.

14. The method of claim 12, wherein the coal is pulverized and comprises an average particle diameter of from about 50 to about 200 μm.

15. The method of claim 12, wherein the first mixture further comprises a surfactant.

16. The method of claim 15, wherein the surfactant comprises dimethylformamide (DMF).

17. The method of claim 12, further comprising mechanically stirring the first mixture.

18. The method of claim 12, wherein the method yields carbon quantum dot nanoparticles having an average particle size of less than about 10 nm.

19. Carbon quantum dot nanoparticles produced by the method of claim 12.

20. The carbon quantum dot nanoparticles of claim 19, wherein the carbon quantum dot nanoparticles have a maximum fluorescence excitation wavelength of from about 360 nm to about 500 nm and a maximum fluorescence emission wavelength of from about 300 nm to about 400 nm.
